(19) United States
(12) Patent Application Publication
(10) Pub. No.: US 2016/0292621 A1
(43) Pub. Date: Oct. 6, 2016

(54) AUTOMATICALLY IDENTIFYING A PROJECT'S STAFFING-AVAILABILITY RISK

(71) Applicant: International Business Machines Corporation, Armonk, NY (US)

(72) Inventors: Lisa Ciccone, Mississauga (CA); Daniel P. Connors, Pleasant Valley, NY (US); George A. Fioto, Jr., Boca Raton, FL (US); Munish Goyal, Bangalore (IN); Pranav Gupta, Noida (IN); Steven E. Heise, Glen Ellyn, IL (US); Jose Magno A. Junior, Hortolandia (BR); Anthony E. Martinez, Orcas, WA (US); Gyana R. Parija, Haryana (IN); Tracy C, Yasz, Cave Creek, AZ (US)

(21) Appl. No.: 14/672,352

(22) Filed: Mar. 30, 2015

(51) Int. Cl. G06Q 10/06

(52) U.S. Cl. CPC G06Q 10/063118; G06Q 10/0635

(57) ABSTRACT

A method and associated systems for automatically identifying a risk that a staffing resource identified by a proposed project-staffing plan will be unavailable. A computerized project-management tool, in response to receiving a proposed project plan, requests, receives, and aggregates information about other past, present, and expected projects and about expected supplies of, and competing demands for, staffing resources required by the proposed plan. The tool infers patterns, business rules, and trends from the received information, with which it adjusts the proposed project's planned start date, expected availabilities of required staffing resources, and expected competition for staffing resources. The tool then determines a likelihood that a sufficient supply of each of the plan's required staffing resources, as adjusted, will be available at the required times, as adjusted. If the risk is too high, the user may fine-tune the proposed plan by repeating the preceding steps with varying project parameters.

### TECHNICAL FIELD

The present invention relates to optimizing allocation of resources related to staffing requirements.

### BACKGROUND

A project-staffing plan may require workers with certain combinations of skills to be available at specific times, but it is not always possible to satisfy all such requirements associated with a particular plan. When there is more than one way to plan and implement a project, there is no reliable, automated way to select an optimal project plan such that each required staffing resource has a sufficiently high probability of being available when required by the plan.

### BRIEF SUMMARY

A first embodiment of the present invention provides a computerized project-management system comprising a computer, a memory coupled to the computer, and a set of computer-readable hardware storage devices coupled to the computer, wherein the storage devices continually receive and store updated project-management information and further store program code configured to be run by the computer via the memory to implement a method for automatically identifying a proposed project's staffing-availability risk, the method comprising:

the system receiving a proposed project-staffing plan, wherein the proposed plan identifies a set of staffing resources that will be required by the proposed project and a set of dates during which the resources of the set of staffing resources will be required;

the computer, in response to the system receiving the plan, retrieving from the storage devices updated staffing-supply data, comprised by the continually updated project information, wherein the updated supply data identifies an availability of each resource of the set of staffing resources during the dates specified by the proposed plan;

the system, in response to receiving the plan, further retrieving from the storage devices updated staffing-demand data, comprised by the continually updated project information, wherein the updated demand data identifies a set of competing demands for at least one resource of the set of staffing resources during the dates specified by the proposed plan, and wherein the set of competing demands comprises one or more staffing demands by one or more external projects that are distinct from the proposed project;

the system adjusting the updated staffing-supply data and the updated staffing-demand data as a function of the continually updated project information;

the system revising the updated staffing-demand data as a function of a priority assigned to one or more of the external projects;

the system determining a likelihood that the set of staffing resources will be available to the proposed project on the dates identified by the proposed project plan, wherein the determining is performed as a function of the adjusting.

A second embodiment of the present invention provides method for automatically identifying a proposed project's staffing-availability risk, the method comprising:

a computerized project-management system receiving a proposed project-staffing plan, wherein the system comprises a computer and a set of computer-readable hardware storage devices that continually receive and store updated project-management information, and wherein the proposed plan identifies a set of staffing resources that will be required by the proposed project and a set of dates during which the resources of the set of staffing resources will be required;

the computer, in response to the system receiving the plan, retrieving from the storage devices updated staffing-supply data, comprised by the continually updated project information, wherein the updated supply data identifies an availability of each resource of the set of staffing resources during the dates specified by the proposed plan;

the computer, in response to receiving the plan, further retrieving from the storage devices updated staffing-demand data, comprised by the continually updated project information, wherein the updated demand data identifies a set of competing demands for at least one resource of the set of staffing resources during the dates specified by the proposed plan, and wherein the set of competing demands comprises one or more staffing demands by one or more external projects that are distinct from the proposed project;

the system adjusting the updated staffing-supply data and the updated staffing-demand data as a function of the continually updated project information;

the system revising the updated staffing-demand data as a function of a priority assigned to one or more of the external projects;

the system determining a likelihood that the set of staffing resources will be available to the proposed project on the dates identified by the proposed project plan, wherein the determining is performed as a function of the adjusting

A third embodiment of the present invention provides a computer program product, comprising a computer-readable hardware storage device having a computer-readable program code stored therein, the program code configured to be executed by a computerized project-management system comprising a computer, a memory coupled to the computer, and a set of computer-readable hardware storage devices coupled to the computer, wherein the storage devices continually receive and store updated project-management information and further store program code configured to be run by the computer via the memory to implement a method for automatically identifying a proposed project's staffing-availability risk, the method comprising:

the system receiving a proposed project-staffing plan, wherein the proposed plan identifies a set of staffing resources that will be required by the proposed project and a set of dates during which the resources of the set of staffing resources will be required;

the computer, in response to the system receiving the plan, retrieving from the storage devices updated staffing-supply data, comprised by the continually updated project information, wherein the updated supply data identifies an availability of each resource of the set of staffing resources during the dates specified by the proposed plan;

the system, in response to receiving the plan, further retrieving from the storage devices updated staffing-demand data, comprised by the continually updated project information, wherein the updated demand data identifies a set of competing demands for at least one resource of the set of staffing resources during the dates specified by the proposed plan, and wherein the set of competing demands comprises one or more staffing demands by one or more external projects that are distinct from the proposed project;

the system adjusting the updated staffing-supply data and the updated staffing-demand data as a function of the continually updated project information;

the system revising the updated staffing-demand data as a function of a priority assigned to one or more of the external projects;

the system determining a likelihood that the set of staffing resources will be available to the proposed project on the dates identified by the proposed project plan, wherein the determining is performed as a function of the adjusting.

### BRIEF DESCRIPTION OF THE DRAWINGS

FIG. 1 shows a structure of a computer system and computer program code that may be used to implement a method for automatically identifying a project's staffing-availability risk in accordance with embodiments of the present invention.

FIG. 2 is a flow chart that shows steps of an embodiment of the present invention that automatically identify a project's staffing availability risk.

### DETAILED DESCRIPTION

Embodiments of the present invention comprise methods and systems that identify a risk that project-staffing plan will not be able to acquire the staffing resources it needs at the times that it needs them.

This procedure may incorporate a computerized project-management system that may aggregate and analyze a large number of current and historical business, financial, personnel, or project-management records. These records may be located at different physical locations, stored on different platforms, and updated by a large variety of users according to different schedules.

This system may identify subtle patterns in this aggregated data from which it infers trends or interactions among records that have affected success rates of previous project plans or that may affect a likelihood of success of a current project-staffing plan. The computerized project-management system may then use these inferences to dynamically adjust or weight the project plan's requirements for staffing resources and the expected availabilities of those required resources.

Embodiments of the present invention may automatically aggregate these records from electronic sources through computer networks in order to ensure that the aggregated data is current enough to provide an accurate result. Some embodiments provide an iterative or “what-if scenario” function that lets users vary parameters of the project-staffing plan in order to determine whether those variations affect a likelihood that the staffing plan is feasible and satisfies other business requirements.

In certain of these embodiments, the computerized system automatically updates the aggregated data during each what-if iteration in order to ensure that the what-if analysis is accurate. In other embodiments, the system allows a user to choose whether each what-if analysis uses the most current data or whether each what-if scenario is performed with a same set of aggregated data, in order to perform direct comparisons among scenarios.

These methods and systems could not be performed without a computerized project-management system and represent more than a mere application of a business method to a generic computer system. It would be impossible for a human to analyze and detect subtle patterns in the enormous amount of motley data often relevant to a large project. It would also be impossible for a human to perform this method at a speed required for this invention to work. By the time a human, or team of humans, could aggregate, review, and analyze such data, portions of that data could have become obsolete. And there is no possible way that such an analysis could be performed with real-time (or near real-time) performance necessary to enable a user to perform successive what-if scenarios in order to interactively and iteratively fine-tune an acceptable staffing plan.

This document thus describes embodiments of this invention in which a computerized project-management system, in response to receiving a proposed project-staffing plan, returns a “risk score” that characterizes a likelihood that staffing resources required by the plan will not be available when needed. The system performs this task by performing novel resource-availability and project-requirements analyses, and then determining how likely it is that the supply of staffing resources will fail to meet project demands.

In particular, after extracting these supply and demand figures from records of past projects and projections of future staffing availability, the system then adjusts these figures as a function of inferred business rules, patterns, and trends. This information is then used to develop probabilistic profiles to characterize each variation of a candidate project-staffing plan by a risk score that allows a project manager or team leader to select a plan that best satisfies financial, scheduling, and business requirements and offers a greatest probability of being able to timely satisfy its staffing needs.

As described above, some embodiments provide further benefits by offering an iterative, and real-time, interactive, or batch, operating mode that allows a project leader to run successive “what-if” analyses. Such embodiments may, when identifying a risk score associated with a proposed staffing plan, allow a user to vary one or more characteristics of the proposed plan to determine whether an acceptable modification may significantly reduce the project's staffing risk. A user may perform this function repeatedly until the system identifies a plan that presents an acceptable level of risk without compromising other business requirements, such as delivery times, labor costs, or quality of deliverables.

In this way, the present invention may be used, not only to identify staffing-availability risks, but to help project managers mitigate such risks within extrinsic project or business constraints, and based on current information aggregated from multiple sources. Some embodiments may further support such risk-mitigation by describing staffing risks in greater detail. An embodiment might, for example, enumerate precise labor or non-labor costs associated with each project task, identify a critical path that may have resulted from conflicting or too-tightly scheduled staffing projections, or detect and report indirect costs associated with particular staffing requirements.

Some embodiments may thus provide an automated optimization tool that allows a user to identify a project-staffing plan that is most likely to be able to satisfy its staffing requirements while satisfying other constraints inferred from archived or current project or business data, or that are manually specified or revised by a user.

Other embodiments may apply similar optimization techniques in other ways. An embodiment might, for example, be used to identify a likelihood that a project or task is able to access materials, outside services, capital, or other project resources in timely accordance with requirements of a project's resource-management or other type of plan.

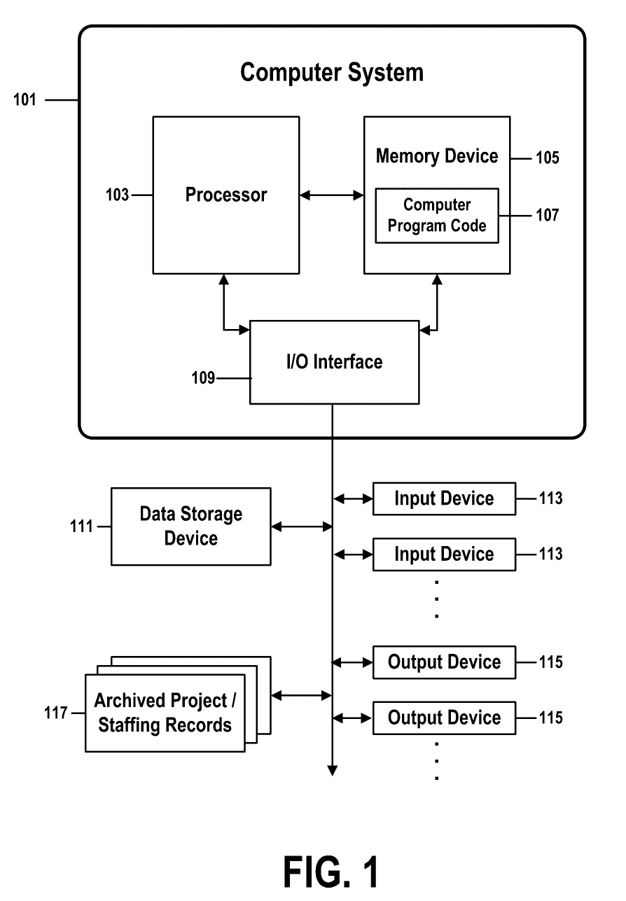

FIG. 1 shows a structure of a computer system and computer program code that may be used to implement a method for automatically identifying a project's staffing-availability risk in accordance with embodiments of the present invention. FIG. 1 refers to objects 101-117.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 and 117 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111 and 117, input devices 113, and output devices 115 may be located either locally or at remote sites from which they are connected to I/O Interface 109 through a network interface.

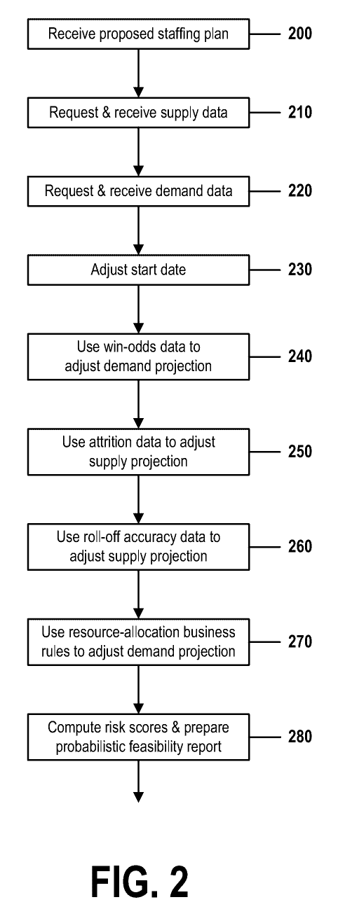

Storage devices 117 may comprise any combination of local and remote nontransitory, virtual or real, storage media that may be distributed among multiple geographical locations, implemented on different platforms, or store data in different formats. This stored data may comprise any sort of current or historical records that a business deems relevant to project-staffing requirements. As will be discussed in FIG. 2, these records may, for example, identify accuracy of past predictions of resource supply or demand, staff attrition rate, start-date slippage, or other implementation-dependent data that may be a function of business, technical, or financial constraints. In some embodiments, these devices 117 may include, but are not limited to, virtual or real computing or storage systems that store databases and logs at multiple locations across an enterprise network or cloud-computing platform.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for automatically identifying a project's staffing-availability risk in accordance with embodiments of the present invention, and may implement other embodiments described in this specification, including the methods illustrated in FIGS. 1-2. The data storage devices 111 may store the computer program code 107. Computer program code 107 stored in the storage devices 111 is configured to be executed by processor 103 via the memory devices 105. Processor 103 executes the stored computer program code 107.

In some embodiments, rather than being stored and accessed from a hard drive, optical disc or other writeable, rewriteable, or removable hardware data-storage device 111, stored computer program code 107 may be stored on a static, nonremovable, read-only storage medium such as a Read-Only Memory (ROM) device 105, or may be accessed by processor 103 directly from such a static, nonremovable, read-only medium 105. Similarly, in some embodiments, stored computer program code 107 may be stored as computer-readable firmware 105, or may be accessed by processor 103 directly from such firmware 105, rather than from a more dynamic or removable hardware data-storage device 111, such as a hard drive or optical disc.

Thus the present invention discloses a process for supporting computer infrastructure, integrating, hosting, maintaining, and deploying computer-readable code into the computer system 101, wherein the code in combination with the computer system 101 is capable of performing a method for automatically identifying a project's staffing-availability risk.

Any of the components of the present invention could be created, integrated, hosted, maintained, deployed, managed, serviced, supported, etc. by a service provider who offers to facilitate a method for automatically identifying a project's staffing-availability risk. Thus the present invention discloses a process for deploying or integrating computing infrastructure, comprising integrating computer-readable code into the computer system 101, wherein the code in combination with the computer system 101 is capable of performing a method for automatically identifying a project's staffing-availability risk.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise the computer-readable hardware storage device.

While it is understood that program code 107 for automatically identifying a project's staffing-availability risk may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for automatically identifying a project's staffing-availability risk is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

FIG. 2 is a flow chart that shows steps of an embodiment of the present invention that automatically identify a project's staffing availability risk. FIG. 2 shows steps 200-280.

In step 200, a component of a computerized project-management system receives a proposed project-staffing plan. This plan will include descriptions of staffing-resource requirements that may each specify:
a required staffing resource which may comprise: a specific worker or class of worker, such as a specifically named engineer, a software designer, or a network specialist; or a skill, such as database administration or facility maintenance; and
a duration of time during which the required staffing resource must be available

This proposed plan may identify a large number of required resources and may further identify prospective sources for some or all of the required resources. In one example, a proposed plan may require sixty computer programmers organized into four groups, each of which is associated with a different type of software, and each of which is only available from one particular Engineering Department.

In step 210, the system responds to receiving the proposed plan by requesting and receiving resource-supply data. This data may be gathered from any number of sources and may be structured or organized in a variety of compatible or incompatible formats. In the preceding example, if the proposed project-staffing plan requires sixty programmers associated with four types of skill sets and four corresponding Engineering groups, the system in this step may request personnel-scheduling records from twelve sites at which the four Engineering Departments maintain staff. The requested information may reside in numerous databases and logs stored on a variety of platforms, such as Windows Server-based database servers, Linux database servers, a distributed human-resource system running under a virtual operating system, and a set of flat-files contained in a transaction-processing system's archived transaction log.

Regardless of implementation details, which are known to those skilled in the art, this retrieved data will identify availability of the requested staffing resources at the times they will be needed by the proposed project plan.

In step 220, the system further responds to receiving the proposed plan by requesting and receiving resource-demand data. Like the resource-availability data, this demand data may be gathered from any number of sources and may be structured or organized in a variety of compatible or incompatible formats. The requested resource-demand information may reside in numerous databases and logs stored on a variety of platforms, such as Windows Server-based database servers, Linux database servers, a distributed human-resource system running under a virtual operating system, and a set of flat-files contained in a transaction-processing system's archived transaction log. This demand information will be described in greater detail below.

A more simple project-planning procedure might at this point attempt to merely match supply and demand figures in order to determine which staffing requirements can be satisfied. If, for example, received records unequivocally state that only three mechanical engineers will be available during March, 2016 in order to satisfy the proposed project plan's requirement for six mechanical engineers, then this simpler procedure would merely identify that the requirement cannot be satisfied. Such a procedure could provide little or no guidance to a project manager seeking to determine whether varying a parameter of the project plan would increase a likelihood that sufficient engineering resources would be available when needed.

Steps 230-270 of the present invention, however, perform a more sophisticated set of adjustments that may more accurately determine likely real-world project requirements and resource availabilities. As described below, these adjustments are performed in response to receiving the most current resource-availability and demand figures in the most recent iteration of steps 210 and 220, and may involve sequences of statistical operations based on information and trends culled from the received availability and demand figures. These operations allow the system to report nuanced likelihoods that the proposed project plan, or some components of the plan, will be able to secure required staffing resources in a timely manner.

In step 230, the system begins analyzing and applying results of the analysis to the proposed project plan. In this step, the system determines whether to adjust the project's proposed start date. In some embodiments, this adjustment may ripple to other dates associated with the project, such as a start date of a particular project task, or a structure of a critical path that is defined as a function of a date associated with one or more tasks on the critical path.

The computerized system may adjust the proposed project start date by performing a statistical or other analysis upon data that compares planned and actual start dates of previous projects. This analysis may be a further function of other parameters, such as a location, time, or business function associated with a project.

In one example, if the system received a proposed plan in step 200 that requires electrical engineers to be available at a Canadian work site, the system in step 230 may analyze past-project data received in step 220 to determine that similar engineering projects started over the last two years at the same (or a similar) site actually started on average two weeks later than the projects scheduled start date. The system might then adjust the project start date, or the start dates of all or some of the tasks comprised by the project, by two weeks.

In a variation of this example, if the proposed project includes tasks unrelated to electrical engineering, the system in this step may adjust start dates of only those tasks that require electrical engineering skills, or dates of those tasks that depend upon tasks that require electrical engineering skills.

In some cases, one or more start dates may be adjusted as a function of data received in steps 210 or 220. In one example, if the received information reveals that start dates of 100 previous project performed all or in part at the proposed project's site, the system may determine start date adjustments through statistical methods known to those skilled in the art. Sites may, for example, be assigned weightings that indicate a degree of similarity to the proposed project's site and amounts of start delay at these sites may be modified by these weightings. In another example, the system may assign weightings to start-date adjustments of past projects as a function of how similar those projects were to the proposed project, or may organize past start-date adjustments into a statistical distribution (such as a Poisson distribution), using the mean or standard deviation of that distribution to determine a most likely start-date adjustment for the proposed project.

Other variations are possible, using computerized statistical methods known to those skilled in the art, in order to infer a most likely starting-date adjustment for the proposed project.

At the conclusion of step 230, the system will have adjusted the start date of the project, and may have further adjusted dates associated with one or more tasks of the project, and these adjustments will have been performed automatically as a function of components of data received in steps 210 and 220.

In step 240, the computerized system analyzes demand data received in step 220 to identify “win odds” characteristics of the proposed project. Here, a project's win odds identifies a likelihood that the project's expected staffing requirements will actually materialize. This may be a function of the project's likelihood to be approved by management, of the likelihood that a client may sign a contract necessary to initiate the project, or that the project will actually require the resources identified in the proposed project plan. In one example, if a client has already signed a contract authorizing the commencement of a project, then that project may be assigned win odds of 100%. If, on the other hand, an unsigned projected is awaiting a commitment from a client that has historically accepted only 10% of proposed projects, that project might be assigned significantly lower win odds.

In some cases, a project's win odds may have been manually entered or otherwise identified by a sales-team member, a manager, a customer representative, or other worker. In other implementations, the project's win odds may be determined by more complex, business-specific or implementation-specific, functions of parameters that may include: the location or country of origin of the project site or of a client, a project history of a particular client, or of extrinsic financial, business, or market conditions. These functions may be defined by methods known to those skilled in the art, or known to those with expert knowledge of the project's goals or of related business priorities.

In one example, if an external “unsigned” project (one that has been offered to a client that has not yet signed a project contract) is deemed in step 240 to have 70% win odds then that project's requirement for ten analysts in May, 2015 might be adjusted to require only seven analysts. Such an adjustment would correspondingly increase an availability of analysts during that month. So, if the proposed project plan identifies a requirement for four of eleven analysts during May, 2015, lowering the unsigned project's requirement from ten analysts to seven analysts would increase a likelihood that the proposed project plan would be able to secure the four analysts it needs during that May.

The system computes win odds for some or all projects and resource demands that may compete for resources identified by the proposed project plan. At the conclusion of step 240, the system will thus have adjusted the projected demand for staffing resources that may reduce the amount of resources available to the proposed project.

In step 250, the system reviews historical attrition records received in step 210 or 220. These records identify patterns of staff attrition that may be used to project ways in which future attrition may affect the supply of staffing resources. This review may consider only attrition records that span a particular period of time, such as the most recent 24 months, or that refer to only particular sites, countries, types of skill, or job functions.

In one example, the received data may indicate that one class of machine operators working in the United Kingdom has experienced, on average, 5% attrition during the month of December during the past three years. If the proposed project-staffing plan requires this class of workers during a future December (after any date adjustments in step 230), then the system will reduce the expected number of available machinists by 5% when determining in step 280 a likelihood that the project's December staffing requirements can be met.

In step 260, the system performs another adjustment to the resource-supply information received in steep 210 by considering “roll-off accuracies” of required staffing resource. Here, a resource's roll-off accuracy identifies an accuracy of a projection of a worker's availability start date if that availability commences when the worker completes another project.

Consider, for example, an NC operator who, because of commitments to other project work through Feb. 18, 2016, is expected to become available to the proposed project on Feb. 19, 2016. The system, in this step, may perform a statistical analysis of past project-completion dates of workers who are similar to the NC operator. If, for example, workers with the same job skill, working at the same location, have historically completed projects on average one week late, then the system in this step may adjust the NC operator's availability to begin on February 26, rather than February 19. In other cases, additional weightings or other statistical factors may result in an adjustment other than one week, but which is nonetheless a function of the historical roll-off accuracy statistics extracted from the data received in step 210.

Although some embodiments perform this analysis on a class of workers and apply the results to a required individual, other embodiments may analyze an individual's historic performance patterns, or may apply the results of a roll-off accuracy analysis to an entire class of workers.

In step 270, the system identifies and implements business rules to prioritize or adjust staffing-resource demands inferred from the information received in step 220. This prioritization allows resources to be allocated to competing tasks or projects such that the most important or the most likely requirements are met first. Other business rules may place further constraints upon an embodiment of the present invention. One such rule might, for example, limit staffing analyses to a specific period, such as forty weeks or eighteen months from the current day. Such a limitation would prevent the system from considering staffing requirements that are expected to materialize too far in the future to be reliably analyzed.

Prioritization business rules may, for example, be used to divide projects or project tasks into categories that are each associated with a resource-allocation priority. When competing for a particular resource, that resource would be more likely awarded to a project or task that has a higher priority.

As mentioned above, projects and tasks may be divided into “signed” and “unsigned” categories, as a function of whether a client has signed a contract required to initiate the project or task. Here, a signed project or task would always have a higher priority than an unsigned project or task. Furthermore, as mentioned in step 240, an unsigned project or task associated with higher win odds may be assigned a higher priority than one that is associated with lower win odds. Other prioritization schemes may be added to this step, as desired by a project manager or system designer.

In step 280, the system performs a probability feasibility analysis that determines a likelihood that the proposed project-staffing plan will be able to successfully access the staffing resources it needs at the required times. This likelihood may be expressed as a single number (a “risk score”) or as a set or table of numbers. In some embodiments, some or all tasks may each be assigned a specific risk score.

This probability analysis is performed via straightforward operational functions that compare the plan's staffing demands to projected resource availability, where both the demand and availability figures have been adjusted in steps 220-270.

The risk score may be a unitless number, or may be expressed as a percent probability, or in any other format that clearly represents relative likelihoods of project success.

In some embodiments, the system may then allow a user to modify one or more characteristics of the proposed project-staffing plan and resubmit it to the system. The method of steps 200-280 would then repeat. In some embodiments, the system might, in this iteration, reuse the data received in the previous iteration steps 210 and 220, or might reuse the adjusted data identified in steps 230-270. In other embodiments, the system would, in this iteration, request and receive updated versions of the data in steps 210 and 220, and then repeat the analysis and adjustments of steps 230-270 on the updated received data.

In some embodiments, the system will allow a user to repeatedly vary one or more parameters of its proposed staffing plan, with the method of steps 200-280 repeating once for each variation. In this way, a user may interactively test “what-if” scenarios in order to identify a staffing plan that has an acceptable likelihood of success or that satisfies other business, financial, or technical constraints.

In this way, a user may use a computerized project-management system based on an embodiment of the present invention to optimize a project-staffing plan such that the optimized plan is characterized by one or more sufficiently low risk scores representing a sufficiently high likelihood that staffing resources required by the plan will be available at times identified by the plan as being associated with each required resource; and may be further characterized as satisfying other user, business, or project constraints, such as being completed by a deadline date or falling within desired budget constraints. In such embodiments, one or more of the other constraints may be manually revised by a user in an iterative or interactive process, as described above. The system may perform this iterative process interactively, in real time or near real-time, regardless of whether the system requests and receives updated data during each repetition of steps 210 and 220.

In some cases, this interactive or iterative ‘what-if scenario” process may identify to a user that it is not possible, or highly unlikely, that any plan can be characterized by both a low risk score (or acceptable likelihood that required staffing resources will be timely available) and by an acceptable likelihood that the plan will satisfy the other constraints. In such cases, the present invention provides a technical advantage by reporting this conclusion to a user with greater nuance, precision, and accuracy, based on the most current information, automatically culled, aggregated, formatted, organized, and mined from possibly heterogeneous, distributed sources, than would be possible through conventional means.

Although FIG. 2 identifies one particular sequence of steps, embodiments of the present invention may perform steps 210-270 in an other rational order. Steps 230-260, for example, may be performed in different order in one embodiment, or steps 240-260 may be performed in a reverse order in another embodiment. In some embodiments, one or more of the adjustments of steps 220-270 may be omitted and, in other embodiments, such omissions may be selected at run time, as a function of a detection that a requested subset of the data received in steps 210 and 220 was omitted or contained too few sample points to assure statistically meaningful results.

What is claimed is:

1. A computerized project-management system comprising a computer, a memory coupled to the computer, and a set of computer-readable hardware storage devices coupled to the computer, wherein the storage devices continually receive and store updated project-management information and further store program code configured to be run by the computer via the memory to implement a method for automatically identifying a proposed project's staffing-availability risk, the method comprising:
the system receiving a proposed project-staffing plan, wherein the proposed plan identifies a set of staffing resources that will be required by the proposed project and a set of dates during which the resources of the set of staffing resources will be required;
the computer, in response to the system receiving the plan, retrieving from the storage devices updated staffing-supply data, comprised by the continually updated project information, wherein the updated supply data identifies an availability of each resource of the set of staffing resources during the dates specified by the proposed plan;
the system, in response to receiving the plan, further retrieving from the storage devices updated staffing-demand data, comprised by the continually updated project information, wherein the updated demand data identifies a set of competing demands for at least one resource of the set of staffing resources during the dates specified by the proposed plan, and wherein the set of competing demands comprises one or more staffing demands by one or more external projects that are distinct from the proposed project;
the system adjusting the updated staffing-supply data and the updated staffing-demand data as a function of the continually updated project information;
the system revising the updated staffing-demand data as a function of a priority assigned to one or more of the external projects;
the system determining a likelihood that the set of staffing resources will be available to the proposed project on the dates identified by the proposed project plan, wherein the determining is performed as a function of the adjusting.

2. The system of claim 1, wherein the adjusting comprises two or more of the steps:
the system adjusting the proposed project's start date, as identified by the proposed plan, as a function of a difference between a planned start date of a previously started project and an actual start date of the previously started project, wherein the planned start date and the actual start date are comprised by the continually updated project information,
the system adjusting a competing demand of the set of competing demands as a function of a chance that one or more of the external projects will not be performed, wherein the chance is automatically inferred from the continually updated project information,
the system adjusting an availability of a first staffing resource of the set of staffing resources as a function of a risk that the first resource will be reduced by personnel attrition during a period of time associated by the proposed plan with the first staffing resource, wherein the risk is automatically inferred from the continually updated project information, and
the system adjusting an availability of a second staffing resource of the set of staffing resources as a function of a probability that a prior commitment of the second staffing resource will end at a time later than an earliest availability date of the second staffing resource identified by the proposed plan.

3. The system of claim 1, wherein the revising comprises:
the system identifying a set of prioritization rules from the continually updated project information;
the system assigning a first priority to a first external project associated with a first competing demand of the set of competing demands; and
the system adjusting the first competing demand as a function of the first priority.

4. The system of claim 1, wherein the proposed project comprises a set of tasks, and wherein the adjusting comprises adjusting a first start date of a first task of the set of tasks, adjusting a first staffing-resource supply of a second staffing resource required by a second task of the set of tasks, or a first competing demand upon a third staffing resource required by a third task of the set of tasks, wherein the first start date, the first staffing-resource supply, and the first competing demand are inferred from the continually updated project information.

5. The system of claim 4, further comprising:
the system further determining a task likelihood that a required task resource of the set of staffing resources will be available at a time identified by the proposed plan, wherein the required task resource is identified by the proposed plan as being required in order to timely perform the first, second, or third task, and wherein the further determining is performed as a function of the adjusting; and
the system reporting the task likelihood to the user as a task risk score.

6. The system of claim 1, further comprising:
the system reporting the likelihood to the user as a risk score.

7. The system of claim 6, further comprising:
the system receiving, in response to the reporting, a user-selected constraint on the project; and
the system repeating the retrieving, the further retrieving, the adjusting, the revising, the determining, and the reporting, wherein the retrieving and further retrieving retrieve newly updated data, and wherein the repeating does not adjust or revise the user-selected constraint.

8. The system of claim 7, wherein the user-selected constraint requires the project to be completed within a user-specified time, at no greater than a user-specified cost, or by consuming no more than a user-specified amount of a resource other than a staffing resource.

9. A method for automatically identifying a proposed project's staffing-availability risk, the method comprising:
a computerized project-management system receiving a proposed project-staffing plan, wherein the system comprises a computer and a set of computer-readable hardware storage devices that continually receive and store updated project-management information, and wherein the proposed plan identifies a set of staffing resources that will be required by the proposed project and a set of dates during which the resources of the set of staffing resources will be required;
the computer, in response to the system receiving the plan, retrieving from the storage devices updated staffing-supply data, comprised by the continually updated project information, wherein the updated supply data identifies an availability of each resource of the set of staffing resources during the dates specified by the proposed plan;
the computer, in response to receiving the plan, further retrieving from the storage devices updated staffing-demand data, comprised by the continually updated project information, wherein the updated demand data identifies a set of competing demands for at least one resource of the set of staffing resources during the dates specified by the proposed plan, and wherein the set of competing demands comprises one or more staffing demands by one or more external projects that are distinct from the proposed project;
the system adjusting the updated staffing-supply data and the updated staffing-demand data as a function of the continually updated project information;
the system revising the updated staffing-demand data as a function of a priority assigned to one or more of the external projects;
the system determining a likelihood that the set of staffing resources will be available to the proposed project on the dates identified by the proposed project plan, wherein the determining is performed as a function of the adjusting.

10. The method of claim 9, wherein the adjusting comprises two or more of the steps:
the system adjusting the proposed project's start date, as identified by the proposed plan, as a function of a difference between a planned start date of a previously started project and an actual start date of the previously started project, wherein the planned start date and the actual start date are comprised by the continually updated project information,
the system adjusting a competing demand of the set of competing demands as a function of a chance that one or more of the external projects will not be performed, wherein the chance is automatically inferred from the continually updated project information,
the system adjusting an availability of a first staffing resource of the set of staffing resources as a function of a risk that the first resource will be reduced by personnel attrition during a period of time associated by the proposed plan with the first staffing resource, wherein the risk is automatically inferred from the continually updated project information, and
the system adjusting an availability of a second staffing resource of the set of staffing resources as a function of a probability that a prior commitment of the second staffing resource will end at a time later than an earliest availability date of the second staffing resource identified by the proposed plan.

11. The method of claim 9, wherein the revising comprises:
the system identifying a set of prioritization rules from the continually updated project information;
the system assigning a first priority to a first external project associated with a first competing demand of the set of competing demands; and
the system adjusting the first competing demand as a function of the first priority.

12. The method of claim 9, wherein the proposed project comprises a set of tasks, and wherein the adjusting comprises adjusting a first start date of a first task of the set of tasks, adjusting a first staffing-resource supply of a second staffing resource required by a second task of the set of tasks, or a first competing demand upon a third staffing resource required by a third task of the set of tasks, wherein the first start date, the first staffing-resource supply, and the first competing demand are inferred from the continually updated project information.

13. The method of claim 9, further comprising:
the system reporting the likelihood to the user as a risk score.

14. The method of claim 13, further comprising:
the system receiving, in response to the reporting, a user-selected constraint on the project; and
the system repeating the retrieving, the further retrieving, the adjusting, the revising, the determining, and the reporting, wherein the retrieving and further retrieving retrieve newly updated data, and wherein the repeating does not adjust or revise the user-selected constraint.

15. The method of claim 9, further comprising providing at least one support service for at least one of creating, integrating, hosting, maintaining, and deploying computer-readable program code in the computer system, wherein the computer-readable program code in combination with the computer system is configured to implement the receiving, retrieving, further retrieving, adjusting, revising, and determining.

16. A computer program product, comprising a computer-readable hardware storage device having a computer-readable program code stored therein, the program code configured to be executed by a computerized project-management system comprising a computer, a memory coupled to the computer, and a set of computer-readable hardware storage devices coupled to the computer, wherein the storage devices continually receive and store updated project-management information and further store program code configured to be run by the computer via the memory to implement a method for automatically identifying a proposed project's staffing-availability risk, the method comprising:
the system receiving a proposed project-staffing plan, wherein the proposed plan identifies a set of staffing resources that will be required by the proposed project and a set of dates during which the resources of the set of staffing resources will be required;
the computer, in response to the system receiving the plan, retrieving from the storage devices updated staffing-supply data, comprised by the continually updated project information, wherein the updated supply data identifies an availability of each resource of the set of staffing resources during the dates specified by the proposed plan;
the system, in response to receiving the plan, further retrieving from the storage devices updated staffing-demand data, comprised by the continually updated project information, wherein the updated demand data identifies a set of competing demands for at least one resource of the set of staffing resources during the dates specified by the proposed plan, and wherein the set of competing demands comprises one or more staffing demands by one or more external projects that are distinct from the proposed project;
the system adjusting the updated staffing-supply data and the updated staffing-demand data as a function of the continually updated project information;
the system revising the updated staffing-demand data as a function of a priority assigned to one or more of the external projects;
the system determining a likelihood that the set of staffing resources will be available to the proposed project on the dates identified by the proposed project plan, wherein the determining is performed as a function of the adjusting.

17. The computer program product of claim 16, wherein the adjusting comprises two or more of the steps:
the system adjusting the proposed project's start date, as identified by the proposed plan, as a function of a difference between a planned start date of a previously started project and an actual start date of the previously started project, wherein the planned start date and the actual start date are comprised by the continually updated project information,
the system adjusting a competing demand of the set of competing demands as a function of a chance that one or more of the external projects will not be performed, wherein the chance is automatically inferred from the continually updated project information,
the system adjusting an availability of a first staffing resource of the set of staffing resources as a function of a risk that the first resource will be reduced by personnel attrition during a period of time associated by the proposed plan with the first staffing resource, wherein the risk is automatically inferred from the continually updated project information, and
the system adjusting an availability of a second staffing resource of the set of staffing resources as a function of a probability that a prior commitment of the second staffing resource will end at a time later than an earliest availability date of the second staffing resource identified by the proposed plan.

18. The computer program product of claim 16, wherein the revising comprises:
the system identifying a set of prioritization rules from the continually updated project information;
the system assigning a first priority to a first external project associated with a first competing demand of the set of competing demands; and
the system adjusting the first competing demand as a function of the first priority.

19. The computer program product of claim 16, further comprising:
the system reporting the likelihood to the user as a risk score.

20. The computer program product of claim 19, further comprising:
the system receiving, in response to the reporting, a user-selected constraint on the project; and
the system repeating the retrieving, the further retrieving, the adjusting, the revising, the determining, and the reporting, wherein the retrieving and further retrieving retrieve newly updated data, and wherein the repeating does not adjust or revise the user-selected constraint.
